(19) United States
(12) Patent Application Publication
(10) Pub. No.: US 2013/0011817 A1
(43) Pub. Date: Jan. 10, 2013

(54) APPARATUS FOR IMPROVING AND/OR MAINTAINING NUMERICAL ABILITY

(76) Inventor: Roi Cohen Kadosh, Oxford (GB)

(21) Appl. No.: 13/578,125

(22) PCT Filed: Feb. 8, 2011
(86) PCT No.: PCT/GB2011/050211

§ 371 Date: Aug. 9, 2012

(30) Foreign Application Priority Data
Feb. 9, 2010 (GB) 1002083.2

(51) Int. Cl. G09B 23/02

(52) U.S. Cl. 434/188

(57) ABSTRACT

The invention relates to an apparatus for improving and/or maintaining the numerical ability of a subject, by modulating the subjects brain activity. The apparatus can be used for rehabilitation and intervention of subjects having mathematical learning difficulties, such as math dyslexia, dyscalculia or acalculia, to maintain the numerical ability, or for enhancing the numerical abilities or proficiency in normal subjects. The invention also extends to methods for improving numerical abilities and/or maintaining numerical ability.

The invention relates to apparatus for improving and/or maintaining the numerical ability of a subject, by modulating the subject's brain activity. The apparatus can be used for rehabilitation and intervention of subjects having mathematical learning difficulties, such as math dyslexia, dyscalculia or acalculia, to maintain the numerical ability, or for enhancing the numerical abilities or proficiency in normal subjects. The invention also extends to methods for improving numerical abilities and/or maintaining numerical ability.

Numerical information plays a key role in science and technology, economy, and in leisure time (e.g., sports). Nevertheless, up to 6.5% of the population struggle with basic numerical understanding, a disability termed dyscalculia, which is suggested to have a developmental origin. Symptoms of dyscalculia include basic understanding of the numerical concept, problems in automatic processing of numerical information, making associations between symbolic meaning and quantity (e.g. the figure “7” and “seveness”), retrieving and memorizing arithmetical facts, and executing efficient calculation procedures. A far higher number of the population have difficulties that are less severe or less specific, but which still cause significant practical, educational and later employment difficulties. The proportion of this population depends in part on the demands for numeracy in a particular society at a given time, but it is likely to be at least 15 to 20% of the population. Moreover, a further proportion of the population will lose their numerical competence during the life span as a result of aging, stroke or degenerative problems, a phenomenon termed acalculia.

Therefore, numerical difficulties constitute a considerable impairment in life which will have a significant impact on people, for example reducing the chance of obtaining an academic education, or leading to increased unemployment, or reduced salary and job opportunities, as well as issues with mental and physical health. This makes numerical disabilities an extremely important field of scientific study with many potential applications in addressing problems in society and education.

Unfortunately, there is currently no medical treatment, therapy or medication available for improving and/or maintaining numerical proficiency or ability. Behavioural interventions exist, for example training programs, such as adaptive computer games for children which aim to remediate dyscalculia in the long run. However, such remediation programs still need to be validated in large group trials, which include a control group in order to examine placebo-like effects.

Therefore, there is a need to provide rehabilitation and intervention for people suffering from mathematical learning difficulties, math dyslexia, dyscalculia or acalculia. The inventor has designed an apparatus and method, which can be used for directly modulating the brain activity, and for inducing neuroplasticity (i.e. the changing of neurones, organisation of networks and their function) in brain areas, which are believed to be involved with numerical ability. The inventor has demonstrated that the apparatus can be effectively used to improve numerical abilities in subjects suffering from mathematical learning difficulties, math dyslexia, dyscalculia or acalculia, to maintain numerical ability, and to improve numerical ability and proficiency in healthy subjects.

Thus, in a first aspect of the invention, there is provided a numerical ability improvement apparatus for improving and/or maintaining the numerical ability of a subject, the apparatus comprising means for delivering an electrical current to the brain of a subject, wherein, in use, the apparatus is adapted to deliver an electrical current to the subject's brain, thereby modulating brain activity and improving and/or maintaining the subject's numerical ability.

The inventor has surprisingly found that enhanced excitation of the subject's brain by the electrical current leads to a measurable improvement in the numerical ability of the subject treated with the apparatus compared to a subject that has not been treated or who has only received placebo treatment, or has received a different type of stimulation. The apparatus stimulates the brain, and leads to higher mathematical proficiency and more accurate representation of numerical information. Not wishing to be bound by any theory, the inventor believes that a weak current applied over a period of time passes through the scalp of the subject, and changes the response of cerebral neurons by influencing spontaneous neural activity. The current is thus believed to induce plasticity (e.g., neurological changes in the grey matter), and changes the efficiency of numerical or mathematical processes in the subject without any detrimental side effects.

The apparatus may comprise means for delivering transcranial direct current stimulation (tDCS) or the like (e.g. transcranial random noise stimulation (tRNS)) to the brain of a subject.

The inventor has found that the numerical proficiency of a subject being treated with the apparatus is augmented when the subject conducts a numerical or mathematical learning/training exercise while simultaneously being subjected to the electrical current.

Thus, in a preferred embodiment, the apparatus may be adapted to deliver the electrical current (preferably as tDCS or tRNS) to the brain of a subject during numerical learning of training. The apparatus may therefore comprise numerical learning or training material, which may be selected from a group consisting of: materials relating to number skills; materials relating to basic numerical skills; materials relating to shape and space skills; materials relating to probability skills; materials relating to magnitude skills; and materials relating to measurement skills.

Materials relating to number skills may comprise exercises involving an addition calculation, a subtraction calculation, a division calculation, a multiplication calculation, learning the multiplication table, abacus, arithmetic algorithms, or facts memory and retrieval. Materials relating to number skills may also be factual, conceptual or procedural knowledge, or arithmetic.

Materials relating to basic numerical skills may comprise reading and writing numbers, counting procedures and enumeration, estimation, understanding of nominal, ordinal, cardinal principles and numerical concepts, using place value and the principle of exchange matching symbolism to number (symbolic and/or non-symbolic numbers), and vice versa, or matching verbal numbers to written numbers, and vice versa, and using an abacus. Materials relating to basic numerical skills may also comprise translation (sub-components: translating from objects to numerals; translating from numerals to objects; translating from number words to numerals and vice versa; translating from number words to objects and vice versa), derived fact strategies, or number fact knowledge.

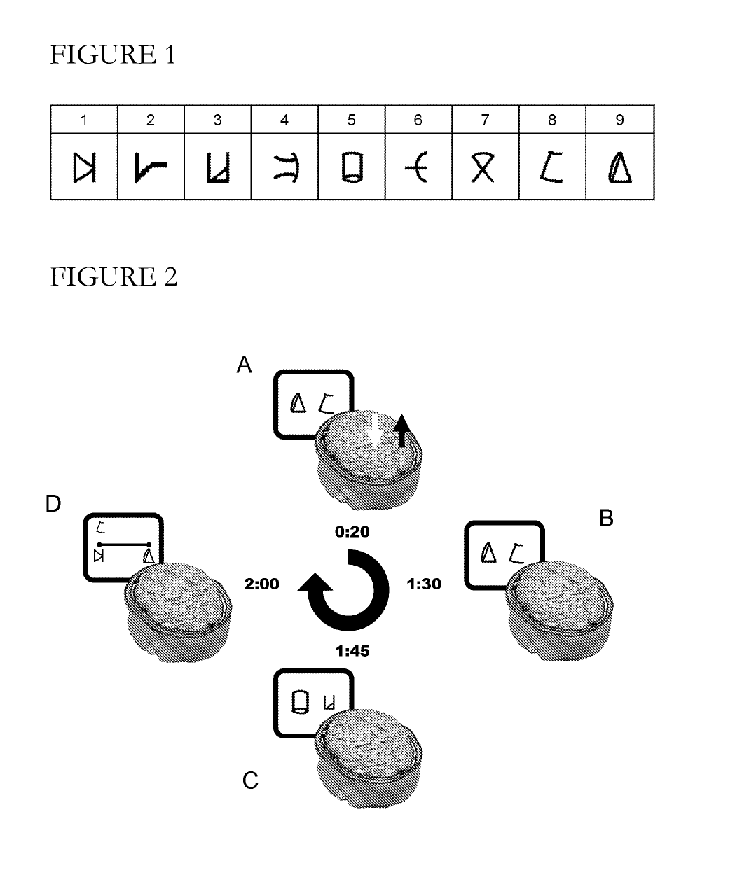

Materials relating to shape and space skills may comprise a mathematical exercise involving shape, symmetry, angles or coordinates. Materials relating to probability skills may comprise a mathematical exercise involving graphs and probability. Materials relating to magnitude skills may comprise a comparison of magnitudes, or a matching of symbols and/or non-symbolic magnitudes. Materials relating to measurement skills may comprise an exercise involving measuring a length, a perimeter, an area, a time, a currency, a weight or a capacity. Alternatively, the numerical learning material may comprise the use of unknown digits (such as foreign (e.g., Kanji) or artificial digits), one embodiment of which is illustrated in FIG. 1.

Typically, tDCS involves the application of a low frequency oscillatory current, or a weak direct current, to modulate the activity of targeted neurons in the subject's brain. The electrical current delivered by the apparatus of the invention to the subject's brain may therefore be between about 0.01 mA and about 50 mA, or between about 0.1 mA and about 30 mA, or between about 0.5 mA and about 20 mA. The current may be between about 0.8 mA and about 10 mA, or between about 0.9 mA and about 5 mA. Preferably, the current is between about 0.8 mA and about 3 mA, or between about 1 mA and about 2 mA. Alternatively, the current may be oscillated between 0.1 mA and 20 mA, or between 1 mA and 10 mA, and between 0.0001 and 1000 Hz, or between 0.0001 and 5 Hz, or between 0.001 Hz and 1 Hz. It will be appreciated that different current intensities and frequencies may apply to different electrodes at different times.

The apparatus may be adapted to deliver the electrical current to the brain for at least 30 s, 1 min, 2 min, 3 min, 4 min, 5 min, 6 min, 7 min, 8 min, 9 min, or 10 min per session. The apparatus may be adapted to deliver the electrical current to the brain for at least 11 min, 12 min, 13 min, 14 min, 15 min, 16 min, 17 min, 18 min, 19 min or at least 20 min per session. The apparatus may be adapted to deliver the electrical current to the brain for less than 6 hours, 5.5 hours, 5 hours, 4.5 hours, 4 hours, 3.5 hours, 3 hours, 2.5 hours, 2 hours, or 1.5 hours per session. The apparatus may be adapted to deliver the electrical current to the brain for less than 60 min, 50 min, 40 min, 30 min, or less than 25 min per session.

It is preferred that the electrical current is sufficient to modulate one or more neurons in the subject's brain. Advantageously, the weak current and short duration provide a sufficiently low threshold, and are relatively painless for a subject using this apparatus.

The apparatus may comprise at least one electrode, which is arranged, in use, to deliver the electrical current to the subject's brain. Preferably, the at least one electrode is adapted to be placed at least adjacent to the subject's head, but also multiple electrodes may be used for optimal stimulation of a target location inside a human brain. In embodiments where the apparatus comprises one electrode, the electrode may be an anode and/or a cathode, i.e. for alternating current the electrode may act as the anode and/or cathode. In embodiments where the apparatus comprises two electrodes, both electrodes may be an anode or a cathode, and/or one electrode may be an anode and the other electrode may be a cathode. In embodiments where there are more than two electrodes all the electrodes can be anode, cathode, or mixed.

The or each electrode may take on a wide variety of different shapes. For example, the at least one electrode may be ring-shaped, circular, rectangular, triangular or square-shaped etc. It will be appreciated that stimulation of a given type of electrode (e.g., cathode) can prime or be primed by another type of electrode stimulation (e.g., anode).

It is preferred that the area of the brain that is stimulated or covered by at least one electrode corresponds to at least 0.1%, 0.5%, 1%, 5%, 10%, 20%, 30%, 40%, 50%, 60%, 70%, 80%, 90%, 95% or 100% of the skull above a selected brain structure of the subject's brain.

When the one or more electrodes are placed on the subject's scalp, the current density produced in the brain is small, changing membrane potentials by only a fraction of a millivolt. tDCS influences maximally the area of the brain directly underneath the electrode that is close to the skull. Therefore, advantageously, the stimulatory effect of the apparatus is area-specific, as opposed to the administration drugs which result in diffuse effects.

Preferably, the at least one electrode is contained within a housing, a portion of which is arranged, in use, to contact the subject's skin. The housing may comprise a conductive material, for delivering the electrical current to the subject. For example, the housing may comprise rubber, which has been attached to saline-soaked pads or specifically designed sponge patches covered with conductive material. The conductive material may be a gel or a salt water solution (e.g., saline). Thus, the electrodes do not directly contact the patient's tissue, thereby reducing the risk of collateral tissue damage, or necrosis and/or excessive electric fields in the tissue.

The apparatus may be arranged, in use, to deliver the electrical current to a parietal cortex and/or the prefrontal cortex and/or the temporal cortex and/or the occipital cortex of the brain. The one or more electrode may therefore be arranged, in use, so that its position substantially corresponds to the position of the parietal cortex and/or the prefrontal cortex and/or the temporal cortex of the brain and/or the occipital cortex. The apparatus may be arranged, in use, to deliver the electrical current to the left and/or right side of any of these brain structures. Preferably, however, the apparatus is arranged, in use, to deliver the electrical current to the left and/or right parietal cortex. Accordingly, the one or more electrode may therefore be arranged, in use, so that its position substantially corresponds to the position of right and/or left parietal cortex.

The inventor considers that induction of neuroplasticity to the parietal cortex can be used to help people with math problems. Typically, the electrode associated with the positive pole (i.e. anode) causes an increase in nerve activity, whereas the electrode associated with the negative pole (i.e. cathode) causes a decrease in nerve activity. Cortical DC polarization is polarity-dependent; it tends to be excitatory when the anodal electrode is located near the dendrites of an isolated neuron (in animals), or placed on the scalp or cortex (in humans). In contrast, when the polarity is reversed and the cathodal electrode is placed near the dendrites or the cortical surface, inhibition of cell firing has been observed. The excitatory stimulation is referred to herein as anodal stimulation, whereas the inhibitory stimulation is referred to herein as cathodal stimulation.

The apparatus may be arranged, in use, to deliver excitatory and/or inhibitory stimulation to a selected brain structure. Accordingly, in one embodiment, the apparatus may be arranged, in use, to deliver excitatory stimulation (referred to herein as anodal stimulation) to the right parietal lobe. In another embodiment, the apparatus may be arranged to deliver inhibitory stimulation (referred to herein as cathodal stimulation) to the left parietal lobe. In a further embodiment, the apparatus may be arranged, in use, to deliver simultaneously excitatory stimulation (i.e. anodal stimulation) to the right parietal lobe and inhibitory stimulation (i.e. cathodal stimulation) to the left parietal lobe. In this embodiment, current density and the selectivity of stimulation to each lobe may be increased.

In another embodiment, the apparatus may be arranged, in use, to deliver anodal (i.e. excitatory) stimulation to the left parietal lobe. The apparatus may be arranged, in use, to deliver cathodal (i.e. inhibitory) stimulation to the right parietal lobe. In another embodiment, the apparatus may be arranged, in use, to simultaneously deliver excitatory stimulation to the left parietal lobe and inhibitory stimulation to the right parietal lobe.

The apparatus may comprise at least one electrical current generator or more for generating the electrical current. The or each electrical current generator may comprise a power source for providing sufficient electrical energy for creating an electrical current. The power source may comprise a battery or batteries, which may be rechargeable. The electrical current generator may further comprise control means for controlling the magnitude and/or frequency and/or duration of the electrical current. The control means may comprise processing means, for example a computer chip.

The apparatus may be in the form of headgear, which comprises the at least one electrode and, optionally, the electrical signal generator. Thus, the apparatus is self-sufficient to not only generate the electrical current described herein, but also deliver the current, to the subject's brain. The electrical signal generator may be located in a pouch or the like, which may be attached to part of the subject's body. For example, the electrical signal generator may be attached to the arm of the subject via an armband. The subject, when using the apparatus, may therefore have the freedom to move around and find a position which is comfortable for learning during exposure to the electrical current. Alternatively, the electric signal generator is located next to the subject.

The headgear may comprise support means for supporting the at least one electrode in a position, which, in use, corresponds to the position of the stimulated brain area (e.g., right and/or left parietal lobe). The apparatus may comprise fastening means for securing the or each electrode on the subject's head. The fastening means may comprise an adjustable strap, lycra, coolmax fabric, or an elastic band, or the like.

The inventor believes that the apparatus of the first aspect may be effectively used for treating subjects suffering from a numerical disorder, for maintaining the numerical ability in a subject (e.g., in elderly), or for treating subjects who are healthy but wish to improve their numerical abilities.

Thus, in a second aspect of the invention, there is provided a numerical improvement apparatus according to the first aspect, for use in improving and/or in maintaining the numerical ability of a subject.

The apparatus may be used to treat a subject suffering from math dyslexia, dyscalculia, or acalculia. The apparatus may be used to maintain a subject's numerical ability, for example, the subject may be an elderly. The apparatus may also be used for enhancing the numerical ability or proficiency in a normal subject. The apparatus may be used to improve and/or maintain numerical skills, such as executing efficient numerical processing or calculations, basic numerical skills, shape and space skills, probability skills, measurement skills. The apparatus may also be used to improve the understanding of numerical concepts, the development of automatic processing of numerical information, making associations between symbolic meaning and quantity, and retrieving and memorizing arithmetic facts. The apparatus may also be used to improve the relationship between visuospatial and/or verbal processes and numerical representation, the understanding of numerical concepts and principles, arithmetic principles, improve approximate and exact calculation, calculation by drill and/or algorithm, and help to reach or even outperform age-adequate arithmetic procedures and strategies. It may also be used to improve reading and writing numbers, remembering numbers, counting procedures and enumeration, estimation, understanding of nominal, ordinal, cardinal principles, using place value and the principle of exchange matching symbolism to number, and vice versa, matching verbal numbers to written numbers, and vice versa, translation (subcomponents: translating from objects to numerals; translating from numerals to objects; translating from number words to numerals and vice versa; translating from number words to objects and vice versa), derived fact strategies, or number fact knowledge.

The inventor has devised a method for improving the numerical abilities or proficiency of a subject.

Therefore, in a third aspect of the invention, there is provided a method for improving and/or maintaining the numerical ability of a subject, wherein the method comprises delivering, to a subject in need of such treatment, an electrical current to the subject's brain, thereby modulating brain activity and improving and/or maintaining the subject's numerical ability.

The method comprises a step of placing at least one electrode on the subject's head, such that its position substantially corresponds to that of a selected structure of the subject's brain. The position of the or each electrode may correspond to the desired stimulated brain area of the subject's brain. The selected structure of the subject's brain may be a parietal cortex and/or the prefrontal cortex and/or the temporal cortex and/or the occipital cortex of the brain. The apparatus may be arranged, in use, to deliver the electrical current to the left and/or right side of any of these brain structures. The selected structure may be the left and/or right parietal lobe.

The method may comprise the subject carrying out a numerical learning exercise or training at the same time as the electrical current is delivered to the brain. The method may comprise the subject carrying out a numerical learning exercise or training shortly before the electrical current is delivered to the brain. The method may comprise the subject carrying out a numerical learning exercise or training shortly after the electrical current is delivered to the brain. For example, the exercise may be selected from a group consisting of: a number skills calculation; a basic numerical skill; a shape and space skills calculation; a probability skills calculation; a magnitude skill; and a measurement skills calculation. The method may comprise the subject carrying out numerical learning exercise for between 3 min and 5 hours, or between 5 min and 5 hours, preferably between 30 min and 3 hours, and more preferably between 45 min and 90 min.

The method may comprise delivering the electrical current to the subject's brain for a period of time sufficient to modulate brain activity in an effective manner.

The electrical current may be delivered to the brain before the beginning of the learning period, at or towards the beginning of the learning period, at or towards the middle of the learning period, or at or towards the end of the learning period, or at the end of the learning period. Preferably, the electrical current is delivered to the brain at the beginning of the learning period.

The delivery of the electrical current to the brain during learning may be carried out at least once, preferably at least twice, and more preferably at least three times. Preferably, the method is repeated every day for at least a week, every 2nd to every 6th day or once a week. The repetition of delivery of the electrical current to the brain during learning may preferably be carried out over a period of 1 day or 1 week up to 2 years. In a preferred embodiment, the repetition is carried out every day over a period of 1 week to up to 1 month. Alternatively, the method is repeated consecutively or non-consecutively for up to at least 2 years. The repetition and duration of the method may vary according to the individual's needs.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention and to show how embodiments of the same may be carried into effect, reference will now be made, by way of example, to the accompanying diagrammatic drawings, in which:

FIG. 1 shows nine artificial digits, and their equivalents in everyday numbers, 1-9 (i.e. Arabic numerals), which are used as stimuli in numerical learning experiments while a subject is being treated with the apparatus and method of the invention;

FIG. 2 shows a schematic outline of the experimental design (clockwise) using the apparatus and method of the invention in order to investigate how the coupling of transcranial direct current stimulation (tDCS) with a learning paradigm for artificial digits impacts on the development of numerical automaticity and the relationship between numbers and space;

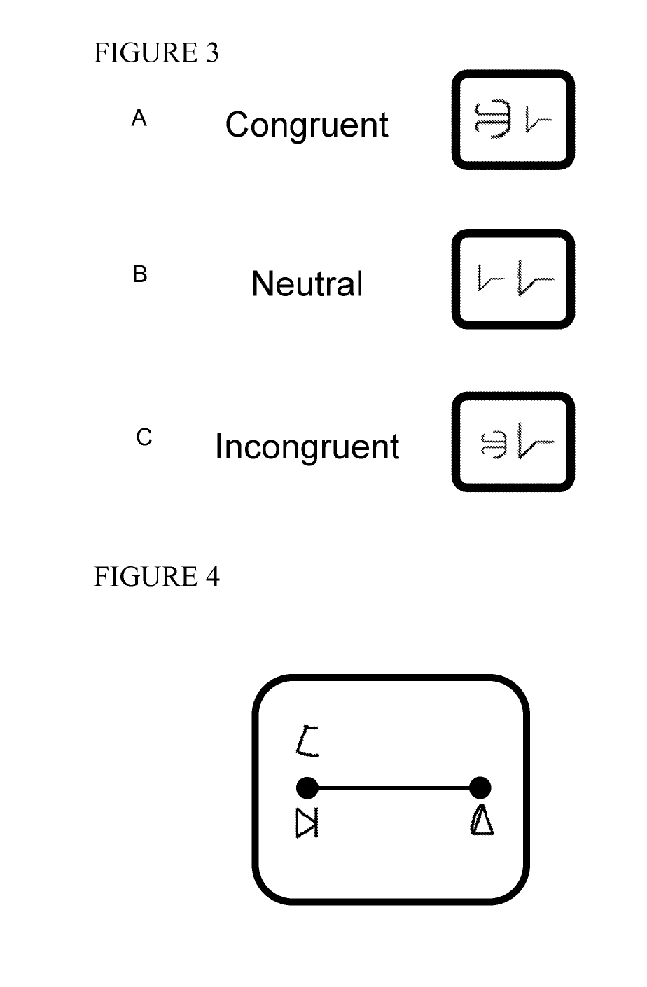

FIG. 3 shows one embodiment of the numerical Stroop task used in the apparatus and method of the invention. A subject is required to determine which of the two artificial digits presented to him or her is physically larger. The two artificial digits presented may be in a congruent (FIG. 3A), neutral (FIG. 3B) or incongruent (FIG. 3C) condition;

FIG. 4 shows one embodiment of the number-space task as appearing on a computer screen;

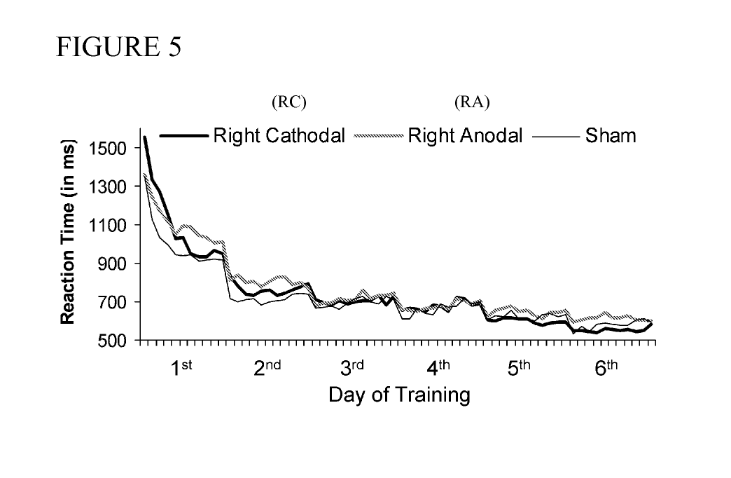

FIG. 5 shows the learning function for groups of subjects who received brain stimulation in various ways. In the Right Cathodal (RC) group, the subjects underwent inhibitory (cathodal) stimulation on the right parietal lobe and excitatory (anodal) stimulation on the left parietal lobe. In the Right Anodal (RA) group, the subjects underwent excitatory (anodal) stimulation on the right parietal lobe and inhibitory (cathodal) stimulation on the left parietal lobe. The sham group represents the control group in which the subjects received minimal stimulation on the left and right parietal lobes. Learning function is represented as reaction time in millisecond (ms) against the number of days of training and number of blocks within each day with exposure to the apparatus;

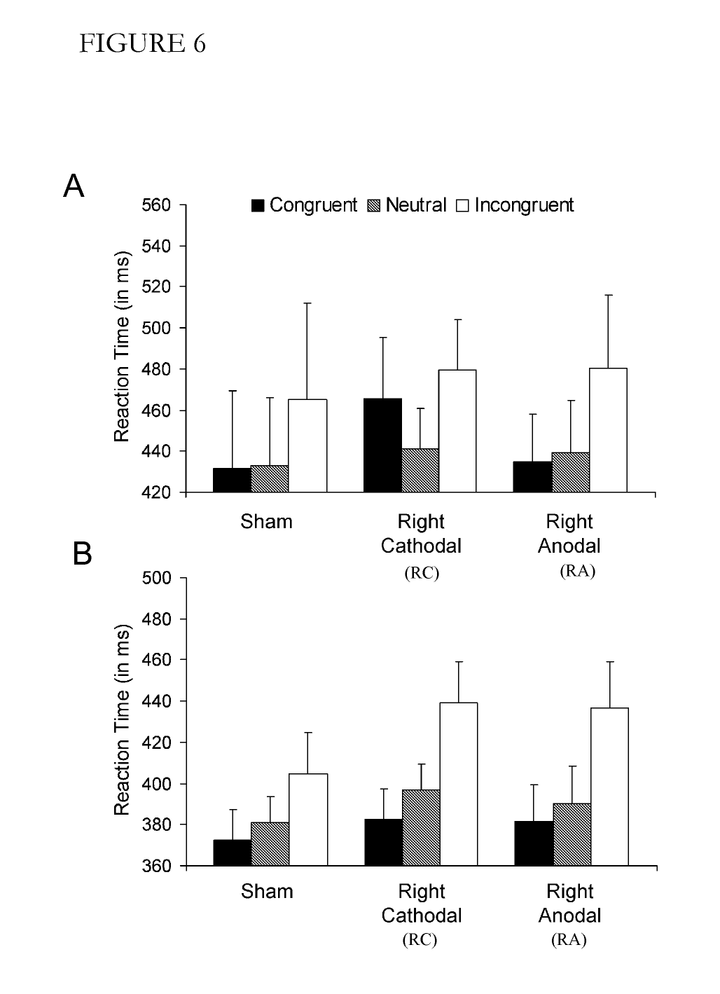

FIG. 6A shows a graphical representation of the results from the numerical Stroop task in which the subjects performed the task using artificial digits shown in FIG. 1, which were learnt during brain stimulation. FIG. 6B shows a graphical representation of the results from the numerical Stroop task in which the subjects carried out the test using everyday digits (i.e. Arabic numerals). The size congruity effects, as represented by reaction time in milliseconds (ms), are shown for the RC, RA and Sham groups. Each error bar denotes one standard error of the mean;

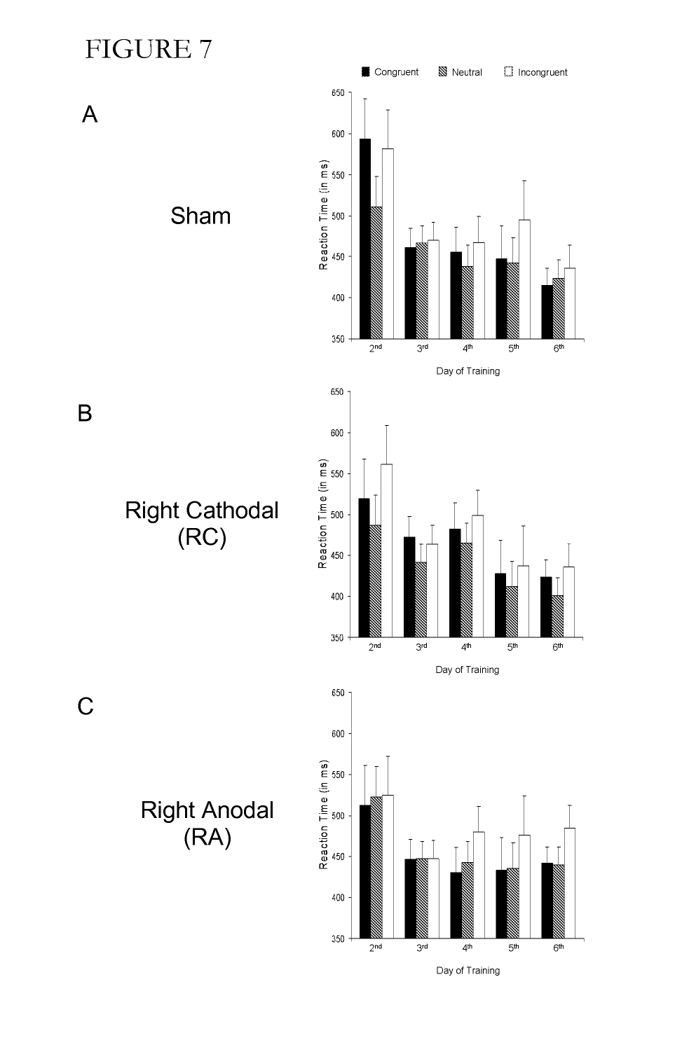

FIG. 7 shows the congruity effects for the Sham group (FIG. 7A), the RC group (FIG. 7B) and the RA group (FIG. 7C) over the course of the study;

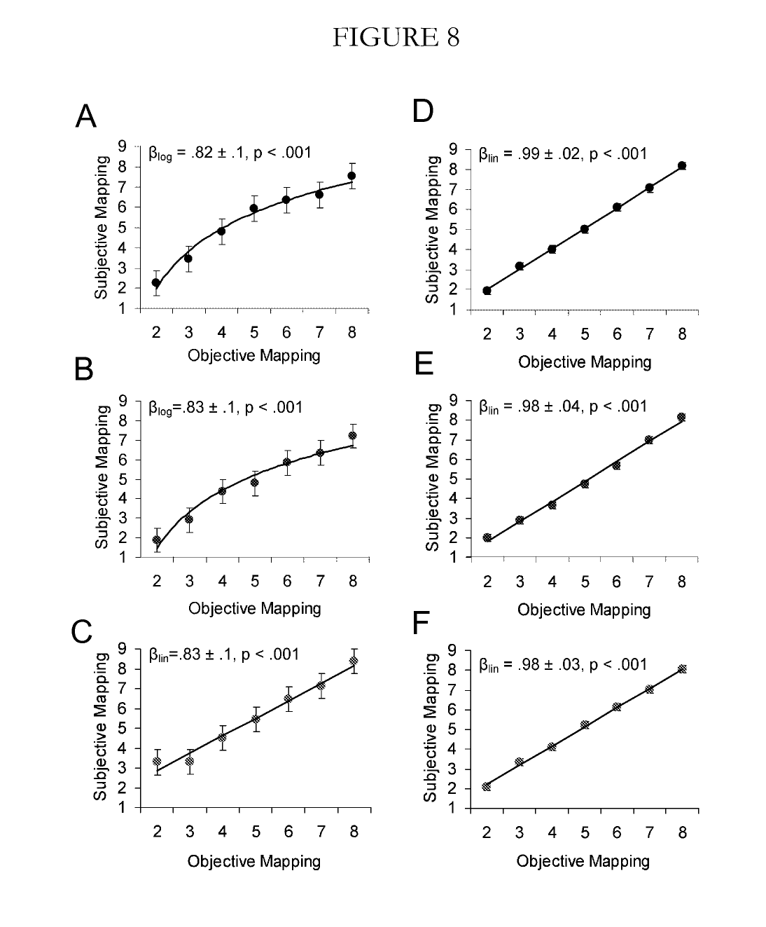

FIG. 8 shows the average location of digits on the horizontal segment with artificial digits (graphs A-C) and everyday digits (graphs D-F). The results for the Sham group are shown in graphs A and D, the RC group in graphs B and E, and the RA group in graphs C and F. β represents the weight of the best predictor, whether it was logarithmic (β_{log}) or linear (βₗᵢₙ), in a multiple regression analysis with logarithmic and linear predictors. Each error bars denotes one standard error of the mean;

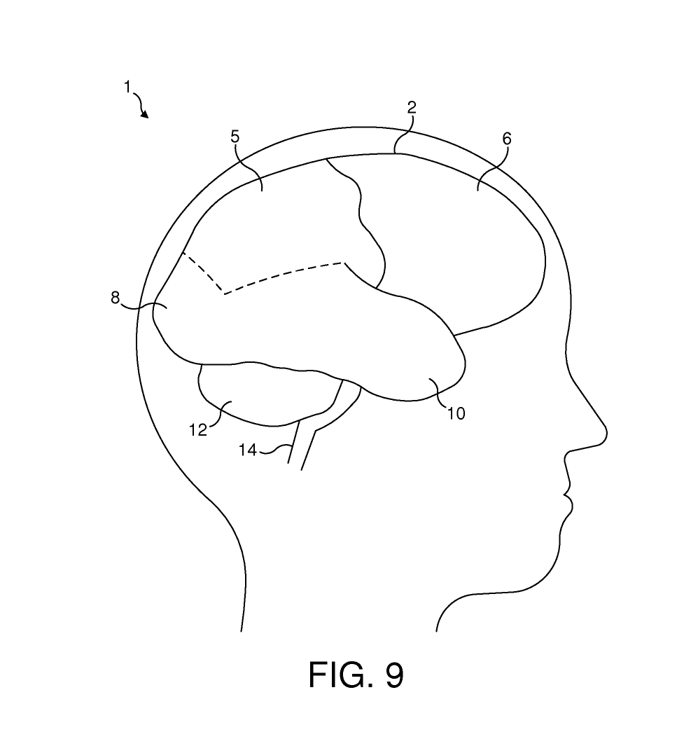

FIG. 9 is a schematic cross-sectional side view of a patient's head showing the regions of the brain;

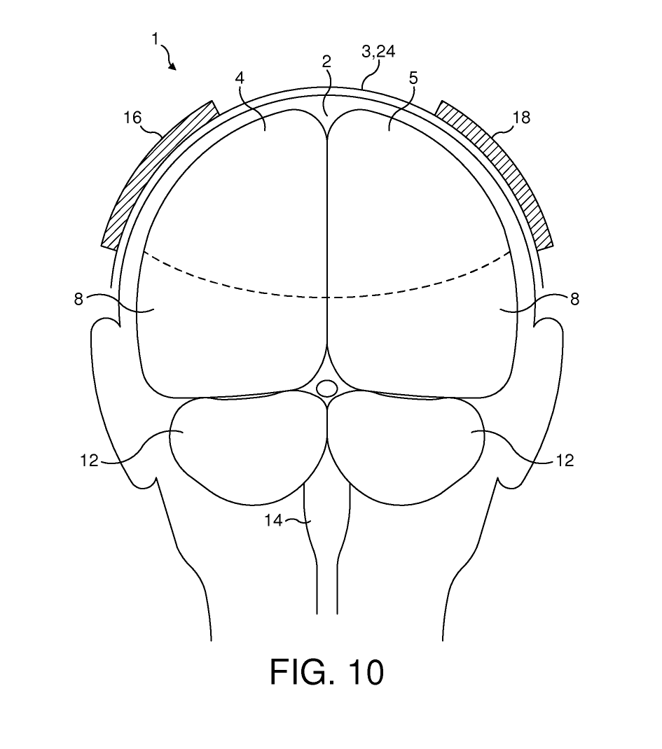

FIG. 10 is a schematic cross-sectional rear view of the patient's head and brain shown in FIG. 9, and a first embodiment of an apparatus according to the invention in position on the patient's head;

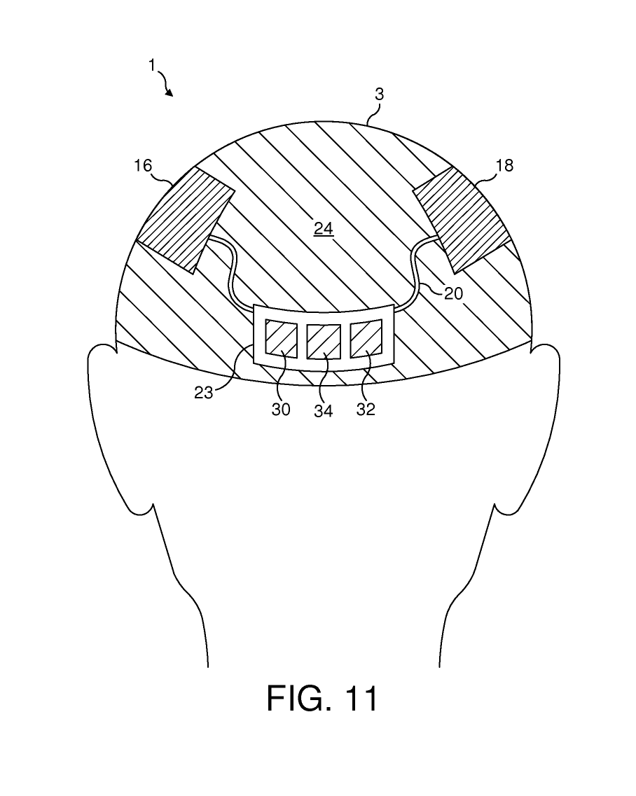

FIG. 11 shows a schematic rear view of the patient's head showing the apparatus in position; and

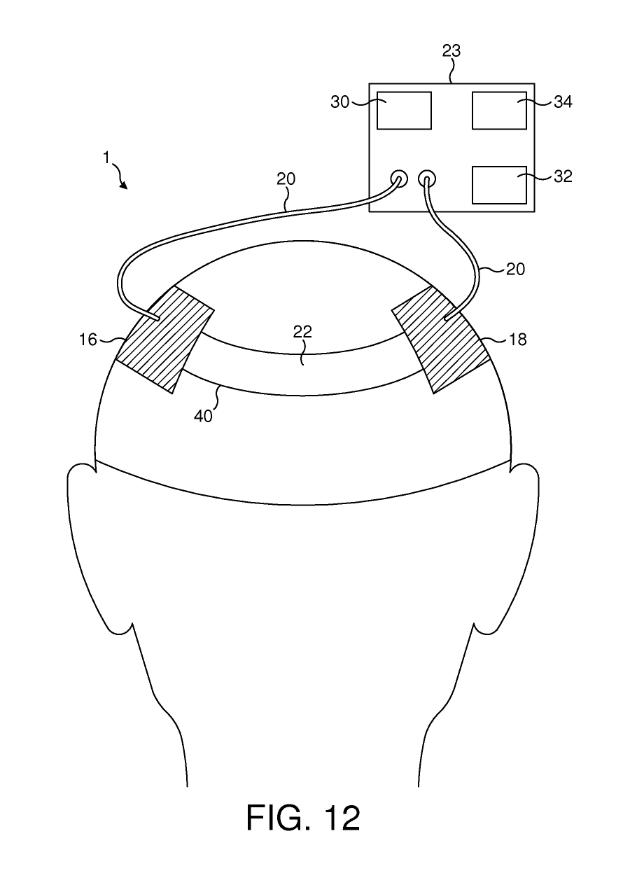

FIG. 12 shows a schematic rear view of the patient's head showing a second embodiment of the apparatus in position.

### EXAMPLES

The inventor carried out a number of experiments, as explained in Example 1, to investigate whether the coupling of brain stimulation with learning affects numerical abilities (Cohen Kadosh, R., Soskic, S., Iuculano, T., Kanai, R., & Walsh, V. (2010). Modulating neuronal activity produces specific and long lasting changes in numerical competence. Current Biology, 20, 2016-2020). Examples 2 and 3 describe two different embodiments of an apparatus of the invention.

### Example 1

Healthy subjects received transcranial direct stimulation (tDCS) at specific areas of the brain while simultaneously learning a new numerical system (e.g. artificial digits). Electrodes were placed on the subject's head, and were aligned to cover the left and right parietal lobes of the brain. FIG. 9 illustrates the position of the parietal lobes 5 of the brain. The implementation of the electrodes is explained below.

The subject was stimulated simultaneously on the left and right parietal lobes in one of the following ways:
1) Right Anodal (RA) group—who received excitatory (anodal) stimulation to the right parietal lobe of the brain, and inhibitory (cathodal) stimulation to the left parietal lobe of the brain for 20 minutes per day;
2) Right Cathodal (RC) group—who received inhibitory (cathodal) stimulation to the right parietal lobe of the brain, and excitatory (anodal) stimulation to the left parietal lobe of the brain for 20 minutes per day; and
3) Sham (control) group—who received stimulation that lasted for 30 seconds per day. In this group, the electrodes were positioned in the same way as for the RA and RC groups.

After the stimulation, the numerical abilities of each of the three groups of subjects were tested. Firstly, the development of automaticity in number processing was investigated using a numerical Stroop task, which is described below. Secondly, the relationship between visuospatial processes and numerical representation was investigated by examining how the subjects mapped numbers onto space in a number-to-space task, which is described below. The subjects' numerical abilities were also tested using Arabic numbers.

Artificial Digits

With reference to FIG. 1, nine artificial digits referred to as Gibson figures (E. P. Gibson et al., Journal of Comparative and Physiological Psychology 55, 897, 1962) were used in the experiments. These artificial digits were assigned to the Arabic numerals 1-9, and subjects were unaware of the Arabic numerals which these artificial digits represented.

Learning the Artificial Digits

Each subject was introduced to the artificial digits described above by learning which artificial digit was numerically larger when compared in pairs. The subject was presented with adjacent pairs of artificial digits (for example, “artificial digit 1” versus “artificial digit 2”), and he or she was asked to compare which artificial digit has a larger magnitude, and feedback was given. Once the subjects were familiar with the artificial digits, they were asked to perform the numerical Stroop task and the number-to-space task, as described below.

Numerical Stroop Task

With reference to FIG. 3, in the numerical Stroop task, two digits of different physical sizes were presented to a subject. The subject was asked to determine which digit was physically larger, without feedback. The two digits presented were non-adjacent pairs (for example, “artificial digit 1” versus “artificial digit 3”) and congruent, incongruent, and neutral conditions were included in order to examine the generation of mental numerical representation. In a “congruent pair”, the numerically larger digit was also physically larger (see FIG. 3A, in which the larger number corresponds to 4, and the smaller number corresponds to 2). In a “neutral pair”, the digits differed only in the physical size (see FIG. 3B, in which both numbers corresponds to the digit 2). In an “incongruent pair”, the numerically larger digit was physically smaller (see FIG. 3C, for the larger physical number which corresponds to 2, and the smaller physical number which corresponds to 4).

A common finding from previous reports, which used Arabic numbers, as reflected by reaction time, was that incongruent trials were slower to be processed than congruent trials (congruity effect). This effect with symbolic numbers characterizes competent numerical ability, and indicates that numbers are processed automatically. In contrast, adults with dyscalculia, and healthy children at the beginning of the first grade show a very negligible effect if at all, or abnormal effects, which are characterised by faster reaction times for the neutral pairs as compared to incongruent and congruent pairs.

Number-Space Task

In the number-space task, each subject was required to map symbols onto a horizontal line. With reference to FIG. 4, the artificial digit corresponding to Arabic number 1 was placed at the left, and the artificial digit representing Arabic number 9 at the right end of the line. The subject was then presented with one of the artificial digits 2 to 8 and he or she was asked to place this artificial digit along the horizontal line according to its magnitude, i.e. its numerical size.

The inventor investigated whether the mapping of the number into space followed a linear or logarithmic scale. In a linear scale, the differences between sets with larger magnitudes (7 vs. 8) are comparable with smaller magnitudes (2 vs. 3), which reflects the fact that the actual quantitative differences themselves are identical. Linear scale, therefore, reflects precise numerical representation, which is common in healthy numerate adults. In a logarithmic scale, the differences between sets with larger magnitudes are less pronounced compared with smaller sets despite the fact that the actual quantitative differences themselves are identical. Logarithmic scale reflects rudimentary numerical abilities that characterise animals, young children, and indigenous tribes.

Previous studies suggested that a log-to-linear shift might occur due to exposure to critical educational material or culture-specific devices such as rulers or graphs. However, all studies that documented the log-to-linear shift involved a population that showed linear mapping due to extensively learned material (i.e., the digits 1-9 that are familiar from schooling) and/or symbolic knowledge. The current paradigm allowed the inventor to reveal that brain stimulation can induce a performance that is characterised by a linear fit independent of exposure to critical educational material or culture-specific devices.

Experimental Design

Fifteen subjects, who were right-handed university students (having a mean age: 21.0 years, between 20-22 year-old), were randomly assigned to the RA, RC and Sham groups. 3 males and 2 females (mean age 21.0) were assigned to the RA group; 3 males and 2 females (mean age 21.0) were assigned to the RC group; and 2 males and 3 females (mean age 21.0) were assigned to the Sham group.

All the subjects carried out a study consisting of 6 sessions for each subject. Each session lasted about 120 minutes each (including electrode placement, and learning and testing phases). The sessions were distributed over a 7 day period, with each subject attending one session per day, except for a break after the 4th day.

Session 1 consisted of a learning task, in which the subjects were introduced to the artificial digits that are shown in FIG. 1. Session 1 also included briefing the subject regarding the experiment, the stimulation method, and health screening. In sessions 2 to 6, the subjects performed the learning task, a numerical Stroop task and a number-space task with the artificial digits from session 1.

In order to examine whether the brain stimulation affected more general perceptual or cognitive abilities, such as everyday numerical processing or visuospatial attention, the subjects were asked at the end of testing on the last day, i.e. on the 7^{th} day, to perform the numerical Stroop task and the number-to-space task with everyday digits (i.e. Arabic numerals).

In summary, the schedule of the study was as follows:

| | | |
|---|---|---|
| Day 1 | Session 1 | Brain Stimulation & learning 20 min |
| | | Learning only ~1 h 10 min |
| Days | Session | Brain Stimulation & learning 20 min |
| 2-4 | 2-4 | Learning only ~1 h 10 min |
| | | Numerical Stroop task 15 min |
| | | Number-to-space task 15 min |
| Day 5 | N/A | Rest |
| Day 6 | Session 5 | Brain Stimulation & learning 20 min |
| | | Learning only ~1 h 10 min |
| | | Numerical Stroop task 15 min |
| | | Number-to-space task 15 min |
| Day 7 | Session 6 | Brain Stimulation & learning 20 min |
| | | Learning only ~1 h 10 min |
| | | Numerical Stroop task with artificial digits 15 min |
| | | Number-to-space task with artificial digits 15 min |
| | | Numerical Stroop task with Arabic digits 15 min |
| | | Number-to-space task with Arabic digits 15 min |

Referring to FIG. 2, there is shown a schematic outline of the experimental design (viewed clockwise) for a subject in the RA group in sessions 2 to 5. tDCS was delivered to the subject under test for 20 minutes from the start of the learning task. During the learning task, excitatory (anodal) stimulation was applied to the right parietal lobe (indicated in FIG. 2A by an upwards black arrow), while inhibitory (cathodal) stimulation was delivered to the left parietal lobe (indicated as a downwards white arrow in FIG. 2A). The learning task continued after the termination of the stimulation for approximately 1 hour 10 min (see FIG. 2B). Once the learning task had ended, the subjects then performed in the numerical Stroop task for 15 min (see FIG. 2C), and followed by the number-to-space task for 15 min (see FIG. 2D). The order of the numerical Stroop task and the number-to-space task was counterbalanced across subjects and sessions. The time adjacent to each picture in FIG. 2 reflects the elapsed time from the beginning of the daily session until the end of the task as shown in the figure.

1. Learning the Artificial Digits

A pair of adjacent artificial digits was compared at a time (a trial) and each trial was repeated 18 times in a random order, i.e. there was a total of 144 comparisons (a block of trials). A training block with 48 trials was performed before performing the learning task. The whole of the learning phase was divided into 11 blocks of trials. Subjects were provided with the average reaction time of the correct answers and percentage of errors after a third, two thirds and the end of each block.

Each trial began with a fixation point (in white ink) for 300 ms at the centre of a black computer screen. After the fixation point disappeared, two symbols (vertical visual angle of) 2.63°) appeared on the computer screen, one symbol in the left visual field, and another in the right visual field. The centre-to-centre distance between the two digits subtended a horizontal visual angle of 9.7°. The pair of symbols remained in view until the participant pressed a key (but not for more than 5 sec). Subjects were asked to respond as quickly as possible, but to avoid mistakes and to indicate their choices by pressing one of two keys (i.e., P or Q on a computer keyboard) corresponding to the side of the display with the selected member of the digit pair. Visual feedback (“Correct Answer”/“Mistake”/“No Response”) was provided for every trial for 500 ms. A new trial began 200 ms after the feedback. The right answer appeared equal times on the right and left sides and all pairs appeared equally often.

2. Numerical Stroop Task

In the numerical Stroop task, pairs of artificial numbers appeared on the screen in the same manner as in the learning task, but the symbols were different in physical size (vertical visual angle of 2.2° or 2.75°) (FIG. 3). Subjects were instructed to choose the physically larger symbol by pressing either P or Q buttons as quickly and as accurately as possible. Only non-adjacent pairs were used and three conditions: congruent (see FIG. 3A), neutral (see FIG. 3B) and incongruent (see FIG. 3C) were included. The three conditions appeared the same number of times, with the right answer appearing equal times on the right and left sides and all pairs appearing equally.

3. Number-to-Space Task

The subjects were asked to map the artificial digits according to their magnitudes onto a horizontal line. A horizontal line appeared across the screen (see FIG. 4). The artificial digit corresponding to the smallest magnitude appeared at the end of the left side of the horizontal line, and the artificial digit corresponding to the largest magnitude appeared at the right end of the horizontal line. The artificial digits to be mapped appeared above the right and left end in a randomised order to avoid any bias in responses that might arise due to the initial location of the artificial digit.

tDCS

Direct current was generated by a Magstim stimulator (The Magstim Company Ltd, UK) and delivered via a pair of identical, rectangular scalp electrodes (3 cm×3 cm) covered with conductive rubber and saline soaked synthetic sponges.

Constant direct current (1 mA) was delivered for 20 minutes at the beginning of each session (i.e. at the beginning of the learning task) through the pair of saline soaked sponge electrodes. At the beginning of the stimulation the current was increased slowly during the first 15 sec to the stimulation threshold (1 mA). At the end of the stimulation the current was decreased slowly to 0 mA during last 15 sec.

Electrodes were positioned over the left and right parietal lobes of the subject's brain according to the 10-20 EEG procedure. According to this procedure the vertex (middle of the head) is localised. Based on that the location called P3, which is located above the left parietal lobe, and P4, which is located above the right parietal lobes, were found. The placement of the electrodes over both parietal lobes increased the specificity of the type of stimulation to each lobe, and increased its effect by increasing the current density.

Subjects in the RA and RC groups received 1 mA for 20 min, and subjects in the Sham group received 1 mA for 30 seconds. The set up for the Sham group was the same as that for RA and RC groups and the subjects were unaware that they were not receiving full stimulation of their brain. Apart from a slight tingling sensation during the stimulation, which diminished rapidly due to habituation, no other discomforts or adverse effects were reported. Although stimulation ended during the learning task, electrodes were kept in place until task completion in order to avoid participant bias.

Safety and Ethical Considerations

Subjects were informed that the experiment was designed to investigate effects of tDCS on cognition, but were kept blind as to the specific relevance to numerical cognition and to the type of stimulation they were receiving. None of the participants reported symptoms of any significant neurological or psychiatric disorders. The study was approved by the local ethics committee and informed written consent was obtained for every subject before the start of each session.

Results

Learning Phase

The data from the learning phase are shown in Table 1, and in FIG. 5.

Table 1 shows the mean reaction time (M) in ms, and one standard error of mean (SEM) for each group, when they were learning the artificial digits.

| | | 1^{st} | | 2^{nd} | | 3^{rd} | | 4^{th} | | 5^{th} | | 6^{th} | |
|---|---|---|---|---|---|---|---|---|---|---|---|---|---|
| | | session | | session | | session | | session | | session | | session | |
| Group | Block | M | SEM | M | SEM | M | SEM | M | SEM | M | SEM | M | SEM |
| RC | 1 | 1557 | 99 | 836 | 87 | 713 | 71 | 656 | 50 | 605 | 49 | 552 | 52 |
| | 2 | 1333 | 97 | 781 | 83 | 697 | 68 | 667 | 48 | 599 | 62 | 552 | 56 |
| | 3 | 1274 | 100 | 738 | 65 | 683 | 61 | 663 | 51 | 617 | 64 | 544 | 52 |
| | 4 | 1147 | 95 | 732 | 64 | 703 | 68 | 648 | 53 | 619 | 69 | 537 | 56 |
| | 5 | 1025 | 108 | 758 | 72 | 691 | 71 | 682 | 57 | 614 | 68 | 559 | 66 |
| | 6 | 1032 | 115 | 761 | 78 | 700 | 70 | 678 | 59 | 609 | 81 | 558 | 55 |
| | 7 | 948 | 103 | 732 | 80 | 703 | 77 | 648 | 55 | 586 | 53 | 549 | 58 |
| | 8 | 934 | 111 | 742 | 73 | 705 | 67 | 723 | 72 | 579 | 55 | 558 | 57 |
| | 9 | 936 | 116 | 759 | 87 | 735 | 80 | 719 | 67 | 587 | 69 | 546 | 55 |
| | 10 | 968 | 118 | 780 | 88 | 685 | 71 | 684 | 64 | 594 | 65 | 549 | 61 |
| | 11 | 952 | 104 | 794 | 92 | 726 | 80 | 690 | 67 | 593 | 64 | 584 | 61 |
| RA | 1 | 1362 | 99 | 812 | 87 | 677 | 71 | 661 | 50 | 624 | 49 | 597 | 52 |
| | 2 | 1246 | 97 | 839 | 83 | 694 | 68 | 657 | 48 | 655 | 62 | 603 | 56 |
| | 3 | 1171 | 100 | 802 | 65 | 692 | 61 | 652 | 51 | 664 | 64 | 619 | 52 |
| | 4 | 1114 | 95 | 807 | 64 | 717 | 68 | 664 | 53 | 676 | 69 | 618 | 56 |
| | 5 | 1051 | 108 | 779 | 72 | 706 | 71 | 665 | 57 | 649 | 68 | 645 | 66 |
| | 6 | 1096 | 115 | 804 | 78 | 709 | 70 | 685 | 59 | 655 | 81 | 617 | 55 |
| | 7 | 1086 | 103 | 828 | 80 | 761 | 77 | 663 | 55 | 626 | 53 | 616 | 58 |
| | 8 | 1047 | 111 | 830 | 73 | 717 | 67 | 717 | 72 | 613 | 55 | 628 | 57 |
| | 9 | 1035 | 116 | 791 | 87 | 734 | 80 | 706 | 67 | 645 | 69 | 606 | 55 |
| | 10 | 1007 | 118 | 799 | 88 | 732 | 71 | 690 | 64 | 645 | 65 | 607 | 61 |
| | 11 | 1013 | 104 | 774 | 92 | 744 | 80 | 706 | 67 | 654 | 64 | 600 | 61 |
| Sham | 1 | 1375 | 99 | 714 | 87 | 670 | 71 | 614 | 50 | 608 | 49 | 536 | 52 |
| | 2 | 1160 | 97 | 694 | 83 | 679 | 68 | 622 | 48 | 629 | 62 | 566 | 56 |
| | 3 | 1009 | 100 | 721 | 65 | 673 | 61 | 659 | 51 | 619 | 64 | 545 | 52 |
| | 4 | 973 | 95 | 736 | 64 | 682 | 68 | 647 | 53 | 643 | 69 | 586 | 56 |
| | 5 | 951 | 108 | 715 | 72 | 691 | 71 | 634 | 57 | 605 | 68 | 591 | 66 |
| | 6 | 945 | 115 | 726 | 78 | 726 | 70 | 690 | 59 | 610 | 81 | 589 | 55 |
| | 7 | 904 | 103 | 732 | 80 | 731 | 77 | 675 | 55 | 600 | 53 | 598 | 58 |
| | 8 | 912 | 111 | 728 | 73 | 702 | 67 | 683 | 72 | 607 | 55 | 574 | 57 |
| | 9 | 908 | 116 | 775 | 87 | 711 | 80 | 715 | 67 | 628 | 69 | 621 | 55 |
| | 10 | 956 | 118 | 774 | 88 | 755 | 71 | 682 | 64 | 626 | 65 | 622 | 61 |
| | 11 | 894 | 104 | 773 | 92 | 740 | 80 | 698 | 67 | 642 | 64 | 601 | 61 |

The data for each individual in each group (see Table 1 for the mean reaction time for each group) were modelled using a power law function in FIG. 5. Referring to FIG. 5, non-linear regression showed an equivalent fit for all three groups (RC, R=0.92; RA, R=0.88; Sham, R=0.85; p=0.46). In addition, the speed of learning and the reaction time for the first block did not differ between the groups (all p>0.33). Therefore, the learning was not affected by the type of brain stimulation.

Numerical Stroop Task with Artificial Digits

The data of the performance in the numerical Stroop task is shown in Table 2, and in FIG. 6A.

Table 2 shows the raw data for the performance in the numerical Stroop task for each group in each session (M=mean reaction time in ms; SEM=one standard error of mean). Bold numbers represent days in which normal congruity effect was observed. Italicised numbers represent abnormal congruity effect.

| | | | 2^{nd} | 3^{rd} | 4^{th} | | |
|---|---|---|---|---|---|---|---|
| | | | ses- | ses- | ses- | 5^{th} | 6^{th} |
| | | | sion | sion | sion | session | session |
| Sham | Congruent | M | 593 | 461 | 456 | 447 | 415 |
| | | SEM | 51 | 20 | 24 | 51 | 26 |
| | Neutral | M | 510 | 466 | 438 | 442 | 424 |
| | | SEM | 33 | 12 | 19 | 36 | 30 |
| | Incongruent | M | 581 | 470 | 466 | 495 | 436 |
| | | SEM | 44 | 17 | 18 | 65 | 31 |
| Right | Congruent | M | 519 | 473 | 483 | 428 | 424 |
| Cathodal | | SEM | 52 | 24 | 40 | 29 | 20 |
| (RC) | Neutral | M | 487 | 441 | 465 | 412 | 401 |
| | | SEM | 33 | 29 | 33 | 15 | 13 |
| | Incongruent | RT | 561 | 464 | 499 | 437 | 436 |
| | | SEM | 45 | 25 | 39 | 22 | 12 |
| Right | Congruent | M | 513 | 447 | 430 | 433 | 441 |
| Anodal | | SEM | 41 | 27 | 25 | 37 | 13 |
| (RA) | Neutral | M | 523 | 447 | 443 | 435 | 440 |
| | | SEM | 44 | 20 | 22 | 37 | 20 |
| | Incongruent | M | 524 | 448 | 480 | 476 | 485 |
| | | SEM | 52 | 22 | 34 | 47 | 35 |

FIG. 6A shows the size congruity effect for the artificial digits for the Sham, RC, and RA groups. The data for each group is averaged across the sessions that show a significant congruity effect.

FIG. 7 shows the results from the numerical Stroop task for the RC, RA and Sham groups over the course of the study. Referring to FIG. 7, all groups showed a reduction in reaction time as a function of training (all p<0.03). However, the performance in the numerical Stroop task differed in all three groups (p=0.035).

Referring to FIG. 7B, the RC group showed an abnormal effect (p=0.03), which was characterised by faster reaction times for the neutral condition in comparison to the congruent and incongruent conditions (p=0.03, quadratic trend analysis (incongruent>neutral<congruent) explained 87% of the variance), while the difference between the congruent and incongruent conditions was not significant (p=0.3). This type of the performance is typical to subjects that do not master numerical knowledge, such as children at the age of 6 years, and reflects perceptual interference rather than semantic interference.

In contrast, the RA group (FIG. 7C) showed an interaction between congruity and training. This interaction was due to a consistent congruity effect (43-50 ms) that was present already from the 4th session (p=0.008), indicating automatic numerical processing. This means that this group reached high level of proficiency with artificial digits and conveyed the semantic meaning in a fluent fashion that demands few mental resources.

Referring to FIG. 7A, the Sham group showed a weaker effect compared to the RA group, and failed to show a significant interaction between congruity and training (p=0.12). However, it seems that in contrast to the RC group which showed atypical congruity effect, and in contrast to the RA group which showed a consistent congruity effect already from the 4th session (4th session congruity effect in the Sham group=10 ms, p=0.6), a typical congruity effect emerged for the Sham group on the 5th and 6th sessions (p=0.048).

Therefore, the observed congruity effect, which indicates automatic processing of numerical information, lets the inventor to conclude that for the Sham group, the data reflects automatic processing of artificial digits. For the RC group, the data indicates a significant, but abnormal, congruity effect for the artificial digits. For the RA group, the data reveals a consistent automatic processing of artificial digits at earlier time point than the Sham condition, and therefore the level of proficiency with numbers emerged earlier in time.

Number-to-Space Task with Artificial Digits

The results for the number-to-space task with artificial digits are shown in FIGS. 8A to C: Sham group (FIG. 8A), the RC group (FIG. 8B) and the RA group (FIG. 8C). Each point on the graph represents the mean location of the subjects in each group at the end of the training. Each error bars represents one SEM.

Logarithmic function was selected as the best predictor in the regression analysis the Sham group and the RC group (see FIG. 8B), while linear function best characterised the RA group (FIG. 8C). As mentioned above, linear function reflects precise numerical representation, which is common in healthy numerate adults, while logarithmic function reflects rudimentary numerical abilities that characterise animals, young children, and indigenous tribes.

In addition, further analysis supports the conclusion that the performance in the number-to-space task was affected by brain stimulation. Namely, as indicated by a main effect for group, a rightward shift (subjective mapping of the number on the physical line to the right of the objective mapping) toward the large number was observed for the RA group (mean=0.59) and to a lesser degree for the Sham group (mean=0.25), a finding which characterises adult performance with everyday digits, which tends to overestimate the true location due to a bias that the large number induce.

In contrast, a leftward shift (subjective mapping of the number on the physical line to the left of the objective mapping), which is associated with children's performance, probably due to the lack of strong cardinal abilities, was observed for the RC group (mean=−0.27) (p=0.023, linear trend analysis (RA>Sham>RC) explained 98% of the variance).

Numerical Stroop Task and Number-to-Space Task with Everyday Digits (i.e. Arabic Numerals)

FIG. 6B shows the results for the numerical Stroop task, and the Sham, RC and RA groups show automatic processing of everyday digits (i.e. Arabic numerals). FIG. 6B shows that, using everyday digits, the subjects showed a normal congruity effect (p=0.00009), which was not varied between the groups (p=0.46).

FIGS. 8D to F show the results for the number-to-space task for the Sham (FIG. 8D) group, the RC group (FIG. 8E) and the RA group (FIG. 8F). The results show that linear scale gave the best fit to the subjects' performance independent of the group, i.e. independent of the type of stimulation that the subject received.

These results indicate that as expected, the performance in these tasks with everyday digits, in contrast to the results with artificial digits, was not modulated by the type of brain stimulation (all p>0.2). Therefore, the brain stimulation was specific to the learned material and did not affect other cognitive processes.

Longterm Effects

Six months after the end of the training, the inventor contacted the subjects from the RA group to examine if their adult-like performance on the tasks with artificial digits persisted. All the subjects except for one were available.

The results at the end of the training (i.e. from session 6) and 6 months after the training are shown in Tables 3 and 4.

Table 3 shows the results for the numerical Stroop task at the end of the training (i.e. from session 6) and 6 months after the training. (M=mean reaction time in ms; SEM=one standard error of mean).

| | End of training | | After 6 months | |
|---|---|---|---|---|
| | | Congruent | | Congruent |
| | Incongruent | and Neutral | Incongruent | and Neutral |
| M | 480 | 437 | 496 | 460 |
| SEM | 36 | 24 | 31 | 21 |

Table 4 shows the results for number-to-space task at the end of the training (i.e. from session 6) and 6 months after the training. (SEM=one standard error of mean).

| Objective | Subjective Mapping | | Subjective Mapping | |
|---|---|---|---|---|
| Mapping | at the end of training | SEM | after 6 months | SEM |
| 2 | 3.29 | 0.62 | 2.26 | 0.67 |
| 3 | 3.32 | 0.62 | 4.63 | 0.67 |
| 4 | 4.53 | 0.62 | 5.74 | 0.67 |
| 5 | 5.43 | 0.62 | 3.99 | 0.67 |
| 6 | 6.48 | 0.62 | 5.60 | 0.67 |
| 7 | 7.13 | 0.62 | 6.26 | 0.67 |
| 8 | 8.39 | 0.62 | 8.02 | 0.67 |

The subjects showed a significant congruity effect, as indicated by a slower reaction time for the incongruent versus neutral and congruent (p=0.04, Table 3). This performance was very similar to the performance at the last day of training 6 month before (interaction between congruity and time. p=0.53; congruity effect of 44 ms at the end of training vs. 36 ms after 6 months). In the number-to-space task, the participants showed a positive correlation between their current mapping and their performance 6 months before (r=0.82, p=0.02), and their performance was best characterised by a linear function (Table 4).

Conclusions

The results show that non-invasive brain stimulation, a tool that can be used to induce plasticity in the brain in healthy subjects and populations of subjects suffering from numerical disabilities, can enhance or impair the development of automatic numerical processing and the interaction between number and space, which are critical indices of numerical abilities.

The inventor has found that, during numerical learning, anodal stimulation to the right parietal lobe, and cathodal stimulation to the left parietal lobe (which enhances and reduces the excitation of neuronal populations, respectively), caused stronger and consistent improved performance in numerical tasks. In contrast, the opposite configuration, i.e. anodal stimulation to the left parietal lobe and cathodal stimulation to the right parietal lobe, led to underperformance, that was similar to those that are observed by young children, or to individuals with rudimentary numerical abilities. Sham stimulation led to a performance that fell between both stimulation groups, namely the subjects did process numerical information automatically, but at a later time than the right anodal group. Furthermore, the mapping of number into space followed a logarithmic function, as with the right cathodal, rather than a linear function, as with the right anodal.

These results suggest that, as with the hemispheric asymmetry found in children, the acquisition of numerical competence in the adult brain may depend on the intact function of the right parietal lobe. Enhanced excitation of the right parietal lobe lead to improved numerical abilities, whereas reduced excitation to the right parietal lobe diminished numerical abilities. In contrast, reduced or enhanced excitation of the left parietal lobe did not seem to impair or improve numerical abilities. These results indicate the contribution of the right parietal lobe to improvement of developmental dyscalculia and mathematical expertise, and provide a causal link between numerical competence and right parietal lobe function.

tDCS did not affect the learning process itself, or automaticity and number mapping with everyday digits, and therefore the current findings are specific to the representation of artificial digits rather than other functions such as visuospatial abilities, attention, or working memory. These findings are important as pharmacological interventions up to now have not been found to be beneficial in the domain of numerical cognition, and might have side-effects on other domains aside from numerical abilities (e.g., attention). In contrast to that, the specificity of the current findings makes the usage of tDCS attractive for future use in the field of rehabilitation of developmental and acquired disorders in numerical cognition. Moreover, tDCS could be used as a method to increase numerical competence in healthy subjects, or to maintain numerical competence, for example in elderly population.

Based on their findings described above, the inventor went on to develop an apparatus, which can be used to treat subjects suffering from numerical disabilities, to enhance numerical abilities in healthy subjects, or to maintain numerical abilities in those who might be likely to loose them. Two embodiments of the apparatus have been developed, and these are described in Examples 2 and 3, respectively.

### Example 2

Referring to FIG. 9, there is shown a human brain 2 disposed inside a subject's head 1. The cerebral hemispheres, consisting of the frontal lobe 6, parietal lobe 5, temporal lobe 10, and occipital lobe 8, form the largest part of the brain, and are positioned above most of the other brain structures. Underneath the cerebrum (i.e. the left and right hemispheres of the brain) lies the brainstem 14, and the cerebellum 12 is located at the rear of the brain 2, beneath the cerebrum and behind the brainstem 14.

FIGS. 10 and 11 illustrate a first embodiment of an apparatus 3 according to the invention. FIG. 10 is a cross-sectional rear view of the subject's head 1, showing the position of the parts of the brain 2 with respect to the various components of the apparatus 3, and FIG. 11 is rear view of the subject's head 1 showing the apparatus 3 in position thereon. In the first embodiment, the apparatus 3 is in the form of a cap or hat 24, which is positioned on to the outer surface of the subject's head 1. The cap 24 can be made of any suitable material, such as textile, plastic, or elastic bands, and should be shaped such that is comfortable for the subject to wear on his head 1. The primary purpose of the cap 24 is to carry and support a left electrode 16 and a right electrode 18, which are shown in FIGS. 10 and 11. The electrodes 16, 18 are rectangular scalp electrodes which are approximately 3 cm×3 cm in dimension. The electrodes 16, 18 are covered with conductive rubber and saline soaked synthetic sponges. When the cap 24 is placed onto the subject's head 1, the left electrode 16 is located on the skull at a position which substantially corresponds to the left parietal lobe 4 of the brain 2, and the right electrode 18 lies in a position which substantially corresponds to the right parietal lobe 5 of the brain 2.

As shown in FIG. 11, the cap 24 also includes an electrical signal source 23, which consists of a power source 30 (e.g. a battery), an electrical current generator 32, and control unit or processor 34. The signal source 23 is electrically connected to the electrodes 16, 18 by means of electrical wires 20. Using power from the power source (e.g. two 1.2V batteries), the current generator 32 creates a transcranial direct current stimulation (tDCS) current of about 1 mA. The control unit 34 is provided to control stimulation threshold, the frequency, and timing in which the 1 mA current is generated, and subjected to the parietal lobes 4, 5 of the subject's brain 2 via the electrodes 16, 18.

When the subject begins his or her numerical learning, the signal source 23 is arranged to create a 1 mA current, which is the directed to the left electrode 16, which delivers inhibitory (i.e. cathodal) stimulation to the left parietal lobe 4 of the subject's brain 2. Simultaneously, a 1 mA current is applied to the right electrode 18, which delivers excitatory (i.e. anodal) stimulation to the right parietal lobe 5. The tDCS is applied to the brain for about 20 min. Examples of suitable numerical learning which can be carried out while the tDCS is applied via the apparatus 2 are provided in Example 1. The subject receives brain stimulation over a period of 2 years. During these 2 years, the subject receives brain stimulation sessions everyday for every other month, i.e. a session a day in January, March, May etc and no sessions in February, April, June etc. Each daily session lasts for about 20 min. The inventor has surprisingly found that this embodiment of the apparatus 3 results in a measurable improvement in numerical abilities in the subject.

### Example 3

Referring to FIG. 12, there is shown a second embodiment of the apparatus 40. The apparatus 40 is in the form of a head strap 22, which retains left and right electrodes 16, 18 in position over the left and right parietal lobes, 4, 5, respectively. The electrodes 16, 18 are connected to a remote electrical signal source 23 consisting of a power source 30, an electrical current generator 32, and control processor 34, via electrical wires 20. The electrical signal source 23 can be placed on a surface adjacent to the subject during treatment, or attached to the body, for example, in an armband. When the apparatus 40 is in use, the subject is seated on a chair, and the head strap 22 supporting the electrodes 16, 18 is appropriately positioned on the subject's head 1. The head strap 22 may be tightened or loosened in order to fit the subject's head, and also to ensure that the electrodes 16, 18 are correctly positioned over the desired structure of the brain 2 (i.e. the parietal lobes 4, 5).

As with the first embodiment of the apparatus 3, the second embodiment 40 is also arranged, when the subject begins his numerical learning, to apply a 1 mA current to the left electrode 16, which delivers inhibitory (i.e. cathodal) stimulation to the left parietal lobe 4, and a 1 mA current to the right electrode 18, which delivers excitatory (i.e. anodal) stimulation to the right parietal lobe 5. The inventors have observed that this embodiment of the apparatus 40 also results in a significant improvement in numerical abilities in the subject following treatment.

### Example 4

In another experiment, adult subjects with low numerical abilities due to developmental origin participated in the experiment described in Example 1. This experiment revealed that those who received cathodal stimulation to the right parietal lobe and anodal stimulation to the left parietal lobe managed to score higher in the number-space task (βlin=0.99, and overall deviation of 0.22) and showed automaticity of numerical processing (congruity effect of 14 ms), while those who received the opposite configuration performed poorly in the number-space task (βlog=0.36, and average absolute deviation of 2.02), and did not show automaticity of numerical processing (abnormal congruity effect of −24 ms). This data surprised the inventor, and showed that the optimal electrode placement might be affected from individual differences, and might be different in different populations, probably due to different brain organisation.

1-32. (canceled)

33. A numerical ability improvement apparatus for improving and/or maintaining the numerical ability of a subject, the apparatus comprising means for delivering an electrical current to the brain of a subject, wherein, in use, the apparatus is adapted to deliver an electrical current to the subject's brain, thereby modulating brain activity and improving and/or maintaining the subject's numerical ability.

34. An apparatus according to claim 33, comprising means for delivering transcranial direct current stimulation (tDCS) or transcranial random noise stimulation (tRNS) to the brain of a subject.

35. An apparatus according to claim 33, wherein the apparatus is adapted to deliver the electrical current to the brain of a subject during numerical learning or training using numerical learning or training material, wherein the material is selected from a group consisting of: materials relating to number skills; materials relating to basic numerical skills; materials relating to shape and space skills; materials relating to probability skills; materials relating to magnitude skills; and materials relating to measurement skills.

36. An apparatus according to claim 33, wherein the electrical current delivered by the apparatus of the invention to the subject's brain is between about 0.01 mA and about 50 mA, or between about 0.1 mA and about 30 mA, or between about 0.5 mA and about 20 mA.

37. An apparatus according to claim 33, wherein the current oscillates between 0.1 mA and 20 mA, or between 1 mA and 10 mA, and between 0.0001 Hz and 1000 Hz, or between 0.001 Hz and 1 Hz.

38. An apparatus according to claim 33, wherein the apparatus comprises at least one electrode, which is arranged, in use, to deliver the electrical current to the subject's brain.

39. An apparatus according to claim 38, wherein the electrode comprises an anode and a cathode.

40. An apparatus according to claim 33, wherein the apparatus is arranged, in use, to deliver the electrical current to the parietal cortex and/or the prefrontal cortex and/or the temporal cortex and/or the occipital cortex of the brain.

41. An apparatus according to claim 33, wherein the apparatus is arranged, in use, to deliver excitatory stimulation to a selected brain structure.

42. An apparatus according to claim 33, wherein the apparatus is arranged, in use, to deliver inhibitory stimulation to a selected brain structure.

43. An apparatus according to claim 33, wherein the apparatus is arranged, in use, to deliver excitatory stimulation to the right parietal lobe.

44. An apparatus according to claim 33, wherein the apparatus is arranged to deliver inhibitory stimulation to the left parietal lobe.

45. An apparatus according to claim 33, wherein the apparatus is arranged, in use, to deliver simultaneously excitatory stimulation to the right parietal lobe and inhibitory stimulation to the left parietal lobe.

46. An apparatus according to claim 33, wherein the apparatus is arranged, in use, to deliver excitatory stimulation to the left parietal lobe.

47. An apparatus according to claim 33, wherein the apparatus is arranged, in use, to deliver inhibitory stimulation to the right parietal lobe.

48. An apparatus according to claim 33, wherein the apparatus is arranged, in use, to simultaneously deliver excitatory stimulation to the left parietal lobe and inhibitory stimulation to the right parietal lobe.

49. An apparatus according to claim 33, wherein the apparatus is in the form of headgear, which comprises at least one electrode.

50. A method for improving and/or maintaining the numerical ability of a subject, wherein the method comprises delivering, to a subject in need of such treatment, an electrical current to the subject's brain, thereby modulating brain activity and improving and/or maintaining the subject's numerical ability.

51. A method according to claim 50, wherein the method comprises placing at least one electrode on the subject's head, such that its position substantially corresponds to that of a selected structure of the subject's brain.

52. A method according to claim 50, wherein the selected structure of the subject's brain is the parietal cortex and/or the prefrontal cortex and/or the temporal cortex and/or the occipital cortex of the brain, preferably the selected structure is the left and/or right parietal lobe.

53. A method according to claim 50, wherein the method comprises the subject carrying out a numerical learning exercise or training at the same time as the electrical current is delivered to the brain, and wherein the electrical current is delivered to the brain before, at, or towards, or after the beginning of the learning period.
